(19) United States
(12) Patent Application Publication
(10) Pub. No.: US 2021/0306569 A1
(43) Pub. Date: Sep. 30, 2021

(54) IMAGING APPARATUS, NOTIFICATION CONTROL METHOD IN IMAGING APPARATUS, AND INFORMATION PROCESSING APPARATUS

(71) Applicant: SONY CORPORATION, TOKYO (JP)

(72) Inventors: TAKAYUKI HATANAKA, KANAGAWA (JP); YUSUKE ONISHI, TOKYO (JP)

(21) Appl. No.: 16/982,583

(22) PCT Filed: Mar. 5, 2019
(86) PCT No.: PCT/JP2019/008565

§ 371 Date: Sep. 20, 2020

(30) Foreign Application Priority Data
Mar. 28, 2018 (JP) 2018-062058

(51) Int. Cl. H04N 5/232; G06F 3/041; G06F 3/01; G08B 6/00

(52) U.S. Cl. CPC H04N 5/232933; G06F 3/041; G08B 6/00; G06F 3/016; G06F 3/013

(57) ABSTRACT

To provide an imaging apparatus that notifies a user on the basis of a change in a touch position on a screen. The imaging apparatus includes a detection unit that detects the touch position with respect to a detection region; and a control unit that controls a notification on the basis of a relationship between a first touch position detected by the detection unit and a second touch position detected after the first touch position. A vibration unit that gives vibration to the imaging apparatus is further included, and the control unit detects that the touch position is about to move out of a predetermined detection region on the screen, and controls the notification by the vibration. Furthermore, the control unit controls the notification on the screen of the display unit.

### TECHNICAL FIELD

The technology disclosed in the present specification relates to an imaging apparatus that notifies a user who performs an operation of touching a screen, a notification control method in the imaging apparatus, and an information processing apparatus.

### BACKGROUND ART

Imaging apparatuses such as digital cameras, which are currently widespread, generally include an electronic or optical finder and a monitor screen such as a liquid crystal. Furthermore, many of the monitor screens include a touch panel as a user's input means (for example, see Patent Document 1).

Furthermore, in the imaging apparatus configured as described above, a touch pad AF function for moving a focus frame on a monitor screen with a fingertip is also known. A user (person who performs capturing) can move the focus frame position smoothly by swiping on the touch panel on the back surface of the main body while looking through the finder (in other words, while keeping an eye on the finder). However, there is a problem in that the user unintentionally moves the finger out of the detection region of the touch panel while using the touch pad AF function, which makes the operation impossible.

For example, in an electronic device including a display panel, there has been proposed a technology for changing the vibration of a touch panel when the position touched by the user moves between inside and outside the display area (for example, see Patent Document 1). However, when the touch position deviates from a predetermined area and a notification is given by vibration, the user needs to visually check the touch position. For example, when a notification is given by vibration while using the touch pad AF function while looking through the finder in a digital camera, there is a concern that the user has to take the eyes away from the finder and check the notification and misses a valuable photo opportunity.

### CITATION LIST

### Patent Document

Patent Document 1: Japanese Patent Application Laid-Open No. 2017-84044

### SUMMARY OF THE INVENTION

### Problems to be Solved by the Invention

An object of the technology disclosed in the present specification provides an imaging apparatus that notifies a user who performs an operation of touching a screen, a notification control method in the imaging apparatus, and an information processing apparatus.

### Solutions to Problems

A technology disclosed in the present specification has been made in view of the aforementioned problems and a first aspect thereof is an imaging apparatus including:

a detection unit that detects a touch position with respect to a detection region; and

a control unit that controls a notification on the basis of a relationship between a first touch position detected by the detection unit and a second touch position detected after the first touch position.

The imaging apparatus according to the first aspect further includes a vibration unit that gives vibration to the imaging apparatus, in which the control unit is configured to control a notification by the vibration. Then, the control unit detects that the touch position is about to move out of a predetermined detection region on the screen, and controls the notification by the vibration. Furthermore, the control unit may control the notification on the screen of the display unit.

Furthermore, a second aspect of the technology disclosed in the present specification is a notification control method in an imaging apparatus including a display unit and a touch panel superimposed on a screen of the display unit, the notification control method including:

a detection step of detecting a touch position with respect to a detection region set on the display unit; and

a control step of controlling a notification on the basis of a change in the touch position detected in the detection step.

Furthermore, a third aspect of the technology disclosed in the present specification is an information processing apparatus including:

a detection unit that detects a touch position with respect to a detection region; and

a control unit that controls a notification on the basis of a relationship between a first touch position detected by the detection unit and a second touch position detected after the first touch position.

### Effects of the Invention

According to the technology disclosed in the present specification, it is possible to provide an imaging apparatus that notifies a user on the basis of a change in touch position on a screen, a notification control method in the imaging apparatus, and an information processing apparatus.

Note that the effects described in the present specification are merely illustrative and the effects of the present invention are not limited thereto. Furthermore, the present invention may exhibit additional effects other than the above effects.

Still other objects, features, and advantages of the technology disclosed in the present specification will become apparent from the following embodiments and more detailed description based on the accompanying drawings.

### BRIEF DESCRIPTION OF DRAWINGS

FIG. 1 is a diagram showing a configuration example of an imaging apparatus 100.

FIG. 2 is a diagram schematically showing a functional configuration of the imaging apparatus 100.

FIG. 3 is a flowchart showing a processing procedure for controlling an operation of the imaging apparatus 100 according to a touch operation by a user.

FIG. 4 is a flowchart showing a processing procedure of Preprocessing 1.

FIG. 5 is a flowchart showing a processing procedure of Preprocessing 2.

FIG. 6 is a flowchart showing a processing procedure of Preprocessing 3.

FIG. 7 is a diagram showing a state in which a nose is in contact with the outside of the detection region of a touch panel 102.

FIG. 8 is a diagram for explaining a method of determining whether a finger is going out of the detection region of the touch panel 102.

FIG. 9 is a flowchart showing a processing procedure of Preprocessing 4.

FIG. 10 is a diagram for explaining a processing procedure of Preprocessing 4.

FIG. 11 is a diagram exemplifying a shape of a detection region that can be set on the touch panel 102.

FIG. 12 is a flowchart showing a processing procedure for giving a notification of focus by vibration.

FIG. 13 is a flowchart showing an example of a processing procedure of giving a notification of an inter-subject distance by vibration.

FIG. 14 is a flowchart showing another example of a processing procedure for giving a notification of an inter-subject distance by vibration.

FIG. 15 is a flowchart showing an example of a processing procedure for giving a notification of the fact that a specific object has been recognized by vibration.

FIG. 16 is a flowchart showing another example of a processing procedure for giving a notification of the fact that a specific object has been recognized by vibration.

FIG. 17 is a diagram showing an arrangement example of vibration elements of a vibration unit 103.

FIG. 18 is a flowchart showing a processing procedure for guiding a user's finger to a subject by vibration.

FIG. 19 is a diagram showing a configuration example of a screen for guiding to a focus frame position the system of a camera recommends by video presentation.

### MODE FOR CARRYING OUT THE INVENTION

Embodiments of the technology disclosed in the present specification are described in detail below with reference to the drawings.

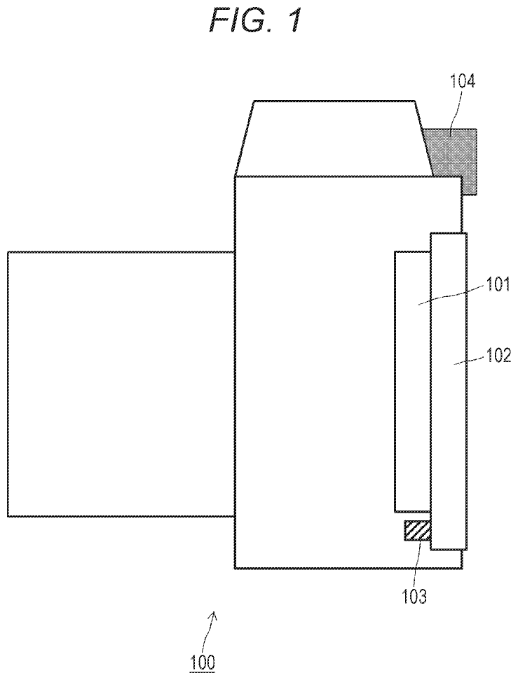

FIG. 1 shows a configuration example of an imaging apparatus 100 to which the technology disclosed in the present specification can be applied. The drawing shows a state obtained as the main body of the imaging apparatus 100 is viewed from the side. The imaging apparatus 100 includes a display unit 101, a touch panel 102, a vibration unit 103, and a finder 104.

The display unit 101 includes, for example, a flat panel display such as a liquid crystal display (LCD) or an organic EL element (OLED), and is used for display of a monitor screen for displaying an image captured by the imaging apparatus 100, and a user interface (UI) such as a menu button.

The touch panel 102 is arranged in a superimposed manner on the display screen of the display unit 101. The touch panel 102 senses, for example, a user operation on the UI displayed on the monitor screen. Furthermore, various user operations related to imaging operations such as touch pad AF can be performed using the touch panel 102. The touch panel 102 may be of any type such as a pressure sensitive type or an electrostatic type.

The vibration unit 103 is arranged, for example, so as to contact the back surface of the touch panel 102 and can apply vibration to the touch panel 102. Details of the vibration control of the vibration unit 103 such as vibration timing, vibration pattern, and amplitude will be described later. As the vibration unit 103, a vibration element such as a vibration actuator or a vibration motor of any operation method can be used. For the sake of convenience of description, the vibration unit 103 is drawn in the side view of FIG. 1, but in practice the vibration unit 103 is disposed inside the housing of the imaging apparatus 100 and is not visible from outside the housing.

Note that the details of the arrangement of the vibration element constituting the vibration unit 103 will be described later.

The finder 104 is a small viewing window provided on the upper back surface of the main body of the imaging apparatus 100 for observing an image captured by the imaging apparatus 100. The finder 104 may be either an electronic finder in which a liquid crystal screen is embedded in the viewing window or an optical finder for directly observing a subject through an imaging lens via a reflection mirror (not shown). The electronic finder includes a flat panel display such as a liquid crystal display (LCD) or an organic EL device (OLED). Note that the finder 104 may include an eye sensor (not shown) that detects that an object such as the user's eye approaches. The detection method of the eye sensor is arbitrary.

The user (person who performs capturing) can observe a captured image from the finder 104. Note that because of the structure in which the display unit 101 and the touch panel 102 are provided on the back surface of the main body of the imaging apparatus 100 and the finder 104 is provided on the upper part of the main body, the nose tip of the user looking through the finder 104 can contact the touch panel 102.

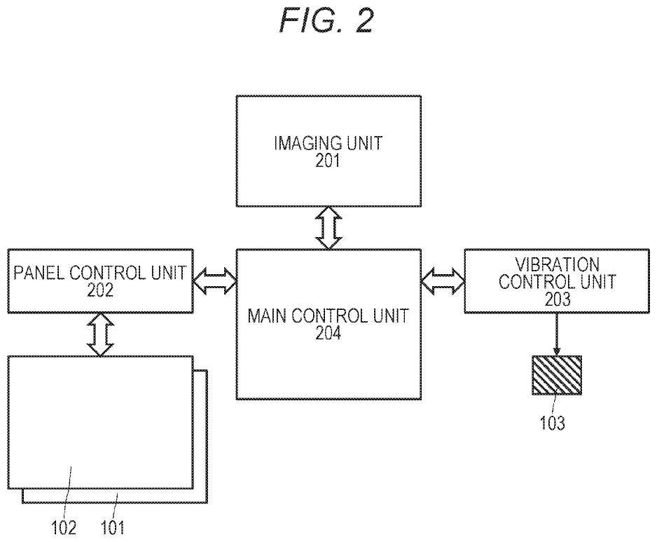

FIG. 2 schematically shows a functional configuration of the imaging apparatus 100. The illustrated imaging apparatus includes an imaging unit 201, a panel control unit 202, a vibration control unit 203, and a main control unit 204.

The imaging unit 201 includes an image sensor such as a complementary metal oxide semiconductor (CMOS) or a charge-coupled device (CCD), and captures a subject image formed on the surface (imaging surface) of the image sensor via an imaging optical system (not shown).

The panel control unit 202 controls display driving of the display unit 101 such as liquid crystal and user input/output via the touch panel 102. Specifically, the panel control unit 202 controls display output of an image captured by the imaging unit 201 or the UI screen onto the display unit 101. Furthermore, the panel control unit 202 detects the coordinates of the position touched by the object (user's fingertip, nose, or the like) on the touch panel 102, and outputs the detection result to the main control unit 204. Note that, for the sake of convenience, the panel control unit 202 is depicted as a single functional block in FIG. 2, but in practice, it can also configured as a separate control circuit chip for input/output control of the display unit 101 and the dutch panel 102.

The vibration control unit 203 controls driving of the vibration unit 103 including one or more vibration elements such as a vibration actuator or a vibration motor. The vibration control unit 203 vibrates the vibration element of the vibration unit 103 in a vibration pattern (vibration cycle, amplitude, number of times, time) based on an instruction from the main control unit 204.

The main control unit 204 centrally controls the entire operation of the imaging apparatus 100. Specifically, the main control unit 204 controls an imaging operation such as exposure and shutter timing in the imaging unit 201, and performs image processing such as AD conversion of an imaging signal of the imaging unit 201, demosaicing, and image quality correction. Furthermore, the main control unit 204 instructs the panel control unit 202 to display a captured image or a UI screen on the display unit 101, receives a detection signal of the touch panel 102 via the panel control unit 202 and controls an imaging operation of the imaging unit 201 in response to a touch operation of the user, or instructs the vibration control unit 203 to perform vibration of the vibration unit 103 (that is, giving a notification to the user using vibration).

In the imaging apparatus 100 according to the present embodiment, the touch operation on the screen of the display unit 101 can be detected by the touch panel 102, and the screen can be vibrated by the vibration unit 103. In addition, the user can operate the touch panel 102 or receive vibration feedback from the touch panel 102 while looking through the finder 104.

In the imaging apparatus 100 including the touch panel 102, for example, when the user uses the imaging apparatus 100 while looking through the finder 104 (for example, while the user uses the touch pad AF function), the following (P1) to (P6) are considered to be operation problems.

(P1) When the finger is unconsciously moved outside the detection region of the touch panel 102, it is necessary to visually check the touch position. While the user is looking away from the finder 104, the user will miss a valuable photo opportunity.

(P2) With the structure in which the finder 104 is provided on the upper part of the main body of the imaging apparatus 100 and the display unit 101 and the touch panel 102 are provided on the back surface of the main body of the imaging apparatus 100, the nose tip of the user looking through the finder 104 can contact the touch panel 102, and the nose can be erroneously detected or erroneously recognized as a finger.

(P3) When the user selects the focus position while observing the monitor screen of the display unit 101, even when the user wants to adjust the focus position near the position where the finger is placed, it is hidden by the fingertip, and there is a problem that it is difficult to make fine adjustments or the focused timing is missed.

(P4) Even when the subject to be focused is designated by touching the touch panel 102, only a notification of the fact that the subject has been focused is given, and there is no information as to how far away from the subject. For example, when a moving object such as a railroad train is to be captured, even when the touch pad AF function or the like is used to specify the front surface of the railroad train as the subject, it will be difficult to capture a photo opportunity when only a notification of the in-focus position is given.

(P5) At the time of capturing, in addition to the subject of interest (or designated on the touch panel 102), an important subject may enter the field of view. Furthermore, in some cases, a subject of interest, which does not move, is to be captured at the moment of movement. When the user does not notice the perfect timing such as the appearance of an important subject or the moment a still subject begins to move, the capturing opportunity will be lost.

(P6) A vibration function installed in an existing device such as a digital camera can express a click feeling by vibrating the region touched by the user, but present only one-dimensional information. It is not possible to present two-dimensional information such as direction.

In the present specification, it is proposed below that the imaging apparatus 100 includes the functions shown in the following (S1) to (S9) for solving the above-mentioned problems (P1) to (P6).

(S1) A function of preventing the user's finger from moving to the outside of the detection region of the touch panel 102 by vibration of the vibration unit 103. Specifically, a function of notifying by vibration that the user's finger has approached the boundary of the detection region of the touch panel 102. The user can continue the operation of the touch panel 102 such as the touch pad AF while preventing the finger from moving out of the detection region of the touch panel 102 without taking the eyes off the finder 104.

(S2) A function of preventing erroneous detection or erroneous recognition of parts other than fingers. For example, a function of changing the detection region of the touch panel 102 so as not to detect a part other than the finger such as the nose tip. Alternatively, a function of determining whether or not it is contact of a part other than the finger such as the nose tip.

(S3) A function that gives a notification of the degree of focus of the subject by vibration. Specifically, a function of changing at least one of the vibration cycle, the amplitude, the number of times, and the time of the vibration unit 103 to give a notification of the degree of focus of the subject. Even when the user cannot see the vicinity of the position on the touch panel 102 where the finger is placed due to the fingertip, the degree of focus can be sensed by vibration, and the timing of focusing can be grasped.

(S4) A function of giving a notification that a preliminarily specified subject is in focus by vibration. The user can suitably capture the subject at the timing when a notification of the focus is given by vibration.

(S5) A function of giving a notification of the distance from the subject by vibration. Specifically, a function of changing at least one of the vibration cycle, the amplitude, the number of times, and the time of the vibration unit 103 to give a notification of the distance from the subject. Since the user can determine the change in the distance from the subject by vibration, it becomes easier to capture the photo opportunity for capturing the subject at a desired distance.

(S6) A function of giving a notification that the subject has been moved to a preliminarily specified distance by vibration. For example, when a moving object such as a railroad train is to be captured, the distance at which the moving object is to be captured is designated in advance, and vibration gives a notification that the railroad train has moved to that distance. Therefore, the user can easily capture a photo opportunity to capture a subject such as a railroad train at a desired distance.

(S7) A function of giving a notification that a preliminarily specified subject appears within a capturing region by vibration. For example, when a specific object such as a rare wild bird or other animal whose movement is irregular and its appearance in a capturing region cannot be predicted in advance, a notification of the fact that the specific object appears in the capturing region is given by vibration. Therefore, the user does not need to chase the subject, but wants at a desired angle of view to easily capture a photo opportunity to capture the subject.

(S8) A function of giving a notification that a preliminarily specified subject has moved by vibration. For example, when the moment when a wild bird flaps or when other animals start moving is to be captured, it is tiring to constantly wait for a photo opportunity with high concentration. With this function, the user is informed that the subject has moved by vibration, and the user can easily take a photo opportunity even when the user is not always under tension.

(S9) A function that gives a sense of direction to vibrations to the fingertips. By presenting in which direction the touch panel 102 is vibrating instead of simply vibrating the touch panel 102, for example, the fingertip can be guided toward the subject.

Note that the details of the arrangement of the vibration elements of the vibration unit 103 for giving a sense of direction to the vibration to the fingertips will be described later.

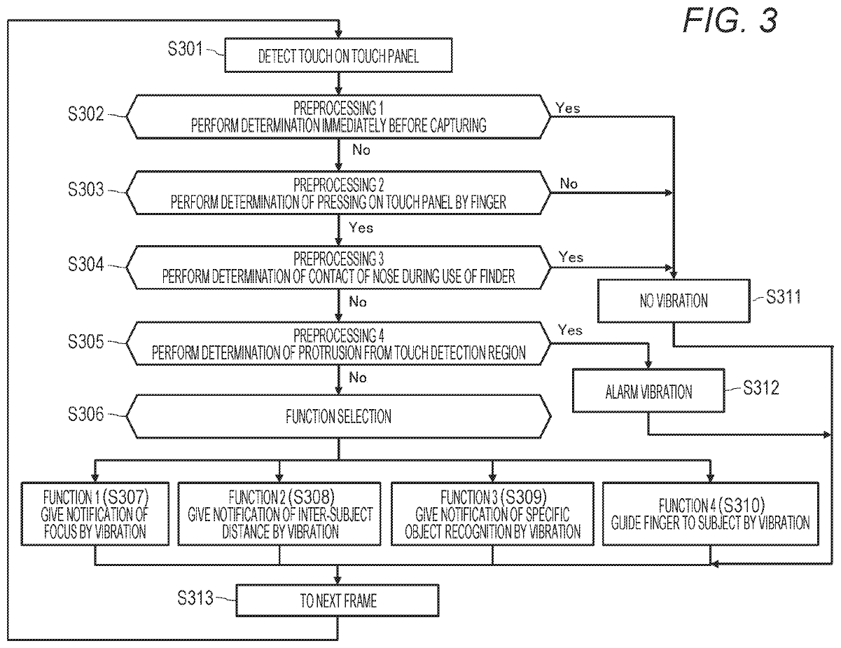

FIG. 3 shows, in the form of a flowchart, a processing procedure for controlling an operation in the imaging apparatus 100 according to the present embodiment in accordance with a touch operation on the touch panel 102 by the user. It is assumed that the processing procedure shown in the drawing is executed for each frame captured by the imaging unit 201 under the overall control of the main control unit 204. Furthermore, the main control unit 204 outputs an instruction to the vibration control unit 203 to vibrate the vibration unit 103.

When touching on the touch panel 102 is detected (step S301), first, as Preprocessing 1, it is determined whether the imaging apparatus 100 is in a state immediately before capturing such as half-pressing of the shutter (not shown) (step S302).

When the imaging apparatus 100 is in a state immediately before capturing (Yes in step S302), the vibration function is turned off (that is, the operation of the vibration unit 103 is prohibited) (step S311) to prevent camera shake or the like during capturing. Moreover, when the in-focus state has elapsed for a certain period of time, it is determined that the image is being captured, and the vibration function is turned off.

On the other hand, when the imaging apparatus 100 is not in the state immediately before capturing (No in step S302), subsequently, as Preprocessing 2, it is determined whether the touch panel 102 is touched with a finger (step S303).

For example, when a part other than the user's finger, such as the palm or forehead, is in contact with the touch panel 102 (No in step S303), the user is not giving an instruction of capturing such as touch pad AF, and the vibration function is turned off (that is, the operation of the vibration unit 103 is prohibited) (step S311). For example, when the contact area with the touch panel 102 is a certain area or more (specifically, an area of 706 square millimeters or more of the circle having a diameter of 30 mm), it can be determined that a portion other than the fingertip is in contact.

When it is determined that the touch panel 102 is being touched with a finger (Yes in step S303), then, as Preprocessing 3, when the user is using the touch pad AF function while looking through the finder 104, it is determined whether contact of the user's nose with the touch panel 102 is erroneously detected as touching with a fingertip (step S304). Note that the details of the method for detecting the contact of the nose will be described later.

When it is determined that the user's nose contacts the touch panel 102 (Yes in step S304), since the contact of the nose is not related to the capturing operation, the vibration function is turned off (that is, the operation of the vibration unit 103 is prohibited) (step S311). Furthermore, in a case where a plurality of vibration elements is arranged as the vibration unit 103, in step S311, only the vibration element closer to the contact location of the nose tip is turned off so that vibration is not given to the nose and the other vibration elements may be left in the ON state. For example, it is possible to determine the place where the contact is made within a predetermined area as the nose.

Note that the user's nose tip may contact the touch panel 102 mainly when the user is looking through the finder 104. Therefore, Preprocessing 3 may be performed when the eye sensor detects the approach of an object to the finder 104.

In a case where it is determined that the finger determined to be touching the touch panel 102 in step S303 is not an erroneous detection of the nose tip or the like (No in step S304), subsequently, as Preprocessing 4, it is determined whether the finger touching the touch panel 102 protrudes outside the touch panel detection area (step S305).

In a case where the user swipes the touch panel 102 while looking through the finder 104 to move the focus frame on the display screen of the display unit 101 using the touch pad AF function, and then the finger is about to come off the detection region of the touch panel 102 (Yes in step S305), the user is warned by the vibration (alarm vibration) of the vibration unit 103 (step S312) to prevent the finger from protruding from the detection region. Details of the method for determining whether the finger is about to come off from the detection region of the touch panel 102 will be described later.

When Preprocessing 1 to 4 described above are ended, the user selects the function of the imaging apparatus 100 (step S306). Basically, it is assumed that the function selection is performed by selecting, on the touch panel 102, one of the function selection menus displayed on the display screen of the display unit 101.

In the present embodiment, it is assumed that the imaging apparatus 100 provides the following four types of functions 1 to 4.

(Function 1) A function to give a notification of the focus by vibration.

(Function 2) A function to give a notification of the inter-subject distance by vibration.

(Function 3) A function to give a notification that a specific object has been recognized by vibration.

(Function 4) A function to guide the finger to the subject by vibration.

In a case where Function 1 is selected in step S306, the main control unit 204 causes the vibration unit 103 to vibrate when the focus of the imaging unit 201 is detected, and vibrates the touch panel 102 only once (step S307).

Furthermore, in a case where Function 2 is selected in step S306, the main control unit 204, for example, when the user is moving the focus frame on the touch panel 102 using the touch pad AF function, notifies the user of the distance from the subject in the focus frame to the imaging apparatus 100 by vibration (step S308).

Furthermore, in a case where Function 3 is selected in step S306, the user sets the specific object in the imaging apparatus 100 in advance. The setting method is arbitrary. For example, the specific object may be set by menu selection on the touch panel 102, or the specific object may be set by voice input. When a preset specific object enters the capturing region of the imaging unit 201, the main control unit 204 notifies the user by changing the vibration type of the vibration unit 103 (step S309).

Function 4 is based on the premise that the imaging apparatus 100 can arrange a plurality of vibration elements as the vibration unit 103 and combine the vibrations of the plurality of vibration elements to express a two-dimensional vibration pattern. Then, in a case where Function 4 is selected in step S306, the main control unit 204 causes the vibration unit 103 to vibrate the touch panel 102 and presents in which direction the vibration is given so as to guide the position of the user's finger to the recommended focus frame position (step S310).

When any one of Functions 1 to 4 is executed according to the result of the function selection by the user in step S306 (steps S307 to S310), the processing returns to step S301 for processing of the next frame (step S313).

Next, details of each step in the flowchart shown in FIG. 3 will be described.

<<Preprocessing 1>>

In Preprocessing 1 of step S302, it is determined whether the imaging apparatus 100 is in a state immediately before capturing such as half-pressing of the shutter (not shown). When the imaging apparatus 100 is in a state immediately before capturing, the vibration function is turned off (that is, the operation of the vibration unit 103 is prohibited). Preprocessing 1 is processing for preventing vibrations because there is a possibility that when the touch panel 102 is vibrated in a state immediately before capturing, it can cause camera shake or disturb the user's operation.

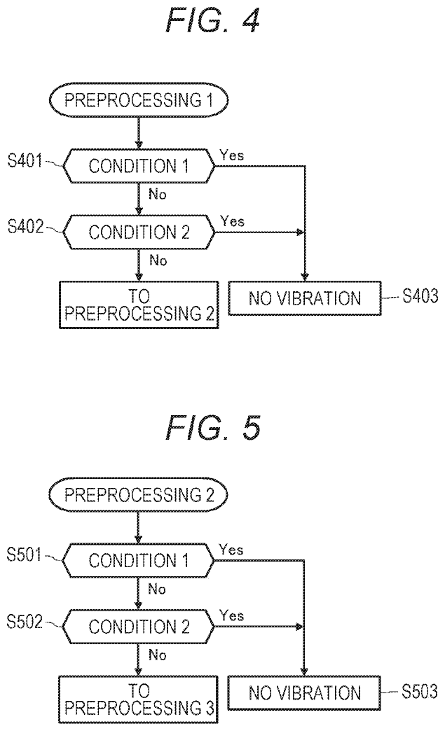

FIG. 4 shows a processing procedure of Preprocessing 1 in the form of a flowchart. Preprocessing 1 is executed under the overall control of the main control unit 204.

The main control unit 204 checks whether Condition 1 of Preprocessing 1 is satisfied (step S401). Then, when Condition 1 is satisfied (Yes in step S401), the vibration function is turned off (that is, the operation of the vibration unit 103 is prohibited) (step S403). Condition 1 of Preprocessing 1 is that, for example, the shutter button (not shown) is in a half-pressed state.

Furthermore, in a case where Condition 1 of Preprocessing 1 is not satisfied (No in step S401), the main control unit 204 subsequently checks whether Condition 2 of Preprocessing 1 is satisfied (step S402). Then, when Condition 2 is satisfied (Yes in step S402), the vibration function is turned off (that is, the operation of the vibration unit 103 is prohibited) (step S403). Condition 2 of Preprocessing 1 is that, for example, a certain period of time (for example, 3 seconds) has elapsed in the focused state of the imaging unit 201. On the other hand, in a case where Condition 2 of Preprocessing 1 is not satisfied (No in step S402), the processing proceeds to Preprocessing 2.

When a certain period of time elapses in the focused state, it can be determined that the imaging apparatus 100 is ready for capturing. In such a case, it is necessary to prevent unnecessary vibration so as not to cause camera shake or interfere with user operation. However, when the imaging unit 201 is no longer in the focused state, Condition 2 described above is canceled and the vibration function is turned on.

Preprocessing 1 is basic processing executed by the imaging apparatus 100. It should be sufficiently understood that when Preprocessing 1 is not performed, the imaging apparatus 100 can inadvertently give an erroneous determination to the user during image capturing.

For example, Condition 2 in step S402 described above is important for making the vibration function of the imaging apparatus 100 easy for the user to use. When there is no function for turning off the vibration function on the basis of this condition determination in Preprocessing 1, if the user keeps touching the touch panel 102 in the focused state, the vibration continues.

<<Preprocessing 2>>

In Preprocessing 2 of step S303, it is determined whether the touch panel 102 is touched with a finger. When an object other than a finger is in contact with the touch panel 102, it does not make sense to vibrate. Thus, Preprocessing 2 is processing for suppressing unnecessary vibration. Furthermore, also in a case where the contact area on the touch panel 102 such as the palm or the forehead of the user is equal to or larger than a certain area, it does not make sense to vibrate. Thus, the vibration function should be turned off.

FIG. 5 shows a processing procedure of Preprocessing 2 in the form of a flowchart. Preprocessing 2 is executed under the overall control of the main control unit 204.

The main control unit 204 checks whether Condition 1 of Preprocessing 2 is satisfied (step S501). Then, when Condition 1 is satisfied (Yes in step S501), the vibration function is turned off (that is, the operation of the vibration unit 103 is prohibited) (step S503). Condition 1 of Preprocessing 2 is that, for example, the contact area with the touch panel 102 is a certain area or more (specifically, an area of 706 square millimeters or more of the circle having a diameter of 30 mm). When the contact area is equal to or larger than a certain area, it can be determined that a portion other than the fingertip is in contact.

Furthermore, in a case where Condition 1 of Preprocessing 2 is not satisfied (No in step S501), the main control unit 204 subsequently checks whether Condition 2 of Preprocessing 2 is satisfied (step S502). Then, when Condition 2 is satisfied (Yes in step S402), the vibration function is turned off (that is, the operation of the vibration unit 103 is prohibited) (step S403). Condition 2 of Preprocessing 2 is that, for example, a specified number of fingers or more are touching the touch panel 102.

For example, in a case where two fingers are touching the touch panel 102, it is assumed that the first finger specifies the focus frame using the touch pad AF function and the second finger sets capturing conditions such as exposure area setting. Therefore, it is meaningless to vibrate the touch panel 102. Furthermore, in a case where three or more fingers are touching the touch panel 102, it is assumed that it is not a capturing state in the first place. Therefore, it is meaningless to vibrate the touch panel 102.

On the other hand, in a case where Condition 2 of Preprocessing 2 is not satisfied (No in step S502), the processing proceeds to Preprocessing 3.

<<Preprocessing 3>>

In Preprocessing 3 of step S304, it is determined whether the touch of the user's nose on the touch panel 102 is erroneously detected as a touch by the fingertip. This is because the user's nose tends to contact the touch panel 102 when the user is using the touch pad AF function while looking through the finder 104. Since the sizes of the nose and the fingertip are similar, when the nose is erroneously determined to be the fingertip in Preprocessing 2, the vibration is also transmitted to the nose tip.

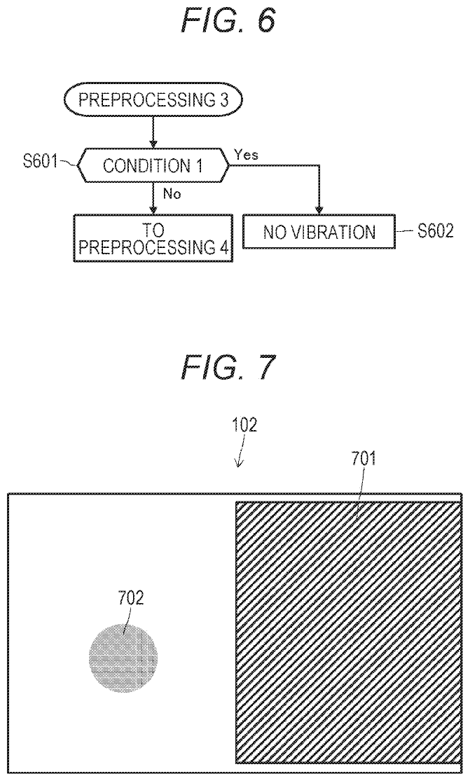

FIG. 6 shows a processing procedure of Preprocessing 3 in the form of a flowchart. Preprocessing 3 is executed under the overall control of the main control unit 204.

The main control unit 204 checks whether Condition 1 of Preprocessing 3 is satisfied (step S601). Condition 1 of Preprocessing 3 is specifically that a touch having a predetermined area or less (for example, a diameter of 20 mm or less) is detected outside the detection region on the touch panel 102.

When the touch panel 102 touches the nose tip instead of the finger, the contact area does not exceed the predetermined area. Furthermore, the user's nose tip may contact the touch panel 102 mainly when the user is looking through the finder 104. Therefore, when the eye sensor detects the approach of an object to the finder 104, a detection region may be set other than a place on the touch panel 102 that the nose tip of the user is likely to come into contact with or a place where contact with a predetermined area or less is detected.

Then, when Condition 1 is satisfied (Yes in step S601), the main control unit 204 determines that the nose of the user contacts the touch panel 102 and turns off the vibration function (that is, prohibits the operation of the vibration unit 103) (step S602). On the other hand, in a case where Condition 1 of Preprocessing 3 is not satisfied (No in step S601), the processing proceeds to Preprocessing 4.

Here, it is assumed that the detection region of the touch panel 102 can be set finely and that operations such as the touch pad AF function and the touch AF function are performed within the detection region of the touch panel 102. Then, Condition 1 of Preprocessing 3 is that the place where the contact is detected on the touch panel 102 is outside the detection region.

FIG. 7 shows a state where the right half of the touch panel 102 is set as a detection region 701 and the left half of the touch panel 102 (that is, outside the detection region) is in contact with a nose tip 702 of the user.

Normally, the finder 104 is arranged on the upper right of the back surface of the main body of the imaging apparatus 100. Therefore, when the focus frame is moved using the thumb of the right hand while the user is looking through the finder 104, the nose tip can unintentionally hit the left half of the touch panel 102.

Therefore, as shown in FIG. 7, the right half of the touch panel 102 is set as the detection region avoiding the place that the nose tip of the user tends to contact, or when the eye sensor detects the approach of an object to the finder 104, the right half of the touch panel 102 is set as the detection region avoiding the contact region 702 equal to or smaller than a predetermined area on the touch panel 102. In this way, the touch region 702 on the nose tip is outside the detection region of the touch panel 102, or because the touch region 702 has a constant area, it is estimated to be the touch by the nose tip instead of the finger, and the vibration function can be turned off in Preprocessing 3 such that the vibration is not transmitted to the nose. Here, as the arrangement of the finder 104, the case where it is arranged at the upper right of the back surface of the main body of the imaging apparatus 100 has been described, but the arrangement is not particularly limited to this, and it can be arranged above the vicinity of the center of the back surface of the main body of the imaging apparatus 100. Depending on the position of the finder 104, it is only required to set the detection region while avoiding a place that the nose tip of the user is likely to contact.

Note that in a case where the vibration unit 103 includes a plurality of vibration elements, in step S602, instead of turning off all of the plurality of vibration elements, only the vibration elements near the place that the nose tip is determined to have touched may be turned off so that the nose is not vibrated, and the vibration elements near the detection region, that is, the place that the user's fingertip touches may be left in the ON state. For example, it is possible to determine the place where the contact is made within a predetermined area as the nose.

Furthermore, the detection region of the touch panel 102 may be set more finely, such as the upper half and the lower half on the right side, in addition to the right half and the left half.

According to Preprocessing 3, in a case where the nose tip is unconsciously hitting the touch panel 102 while the user uses the touch pad AF function while looking through the finder 104, it is possible to prevent unnecessary vibration from being applied to the nose tip.

<<Preprocessing 4>>

In Preprocessing 4 of step S305, it is determined whether the finger of the user operating the touch panel 102 is about to move out of the detection region of the touch panel 102. When the user uses the touch pad AF function while looking through the finder 104, when the finger comes off the detection region of the touch panel 102, there is a concern that the user has to take the eyes away from the finder and make checking and misses a valuable photo opportunity. Preprocessing 4 is processing for preventing the finger from coming off the detection region of touch panel 102.

In Preprocessing 4, it is determined whether the finger is about to move out of the detection region of the touch panel 102. Then, when it is determined that the finger is about to come off the detection region of the touch panel 102, the user is warned by the vibration of the vibration unit 103 (alarm vibration) to prevent the finger from protruding from the detection region.

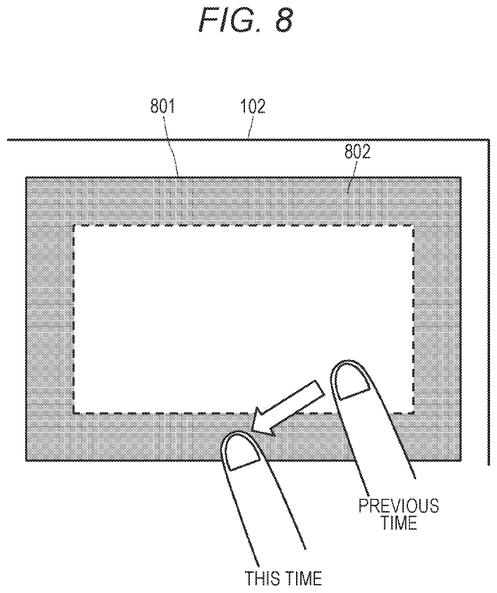

Various methods for determining whether the finger is about to move out of the detection region of the touch panel 102 are conceivable. FIG. 8 illustrates an example of a method for determining whether the finger is about to move out of the detection region of the touch panel 102. A region from the boundary of a detection region 801 set on the touch panel 102 to a predetermined distance (indicated by gray in the drawing) is defined as an outer peripheral specified range 802 as a specified region. Then, it is assumed that the touch position of the fingertip on the touch panel 102 is detected in a predetermined cycle, and when the touch detection coordinates at this time have already entered the outer peripheral specified range 802 and are closer to the boundary of the detection region than the touch detection coordinates at the previous time, the main control unit 204 determines that the touch position of the finger is about to move out of the detection region of the touch panel 102.

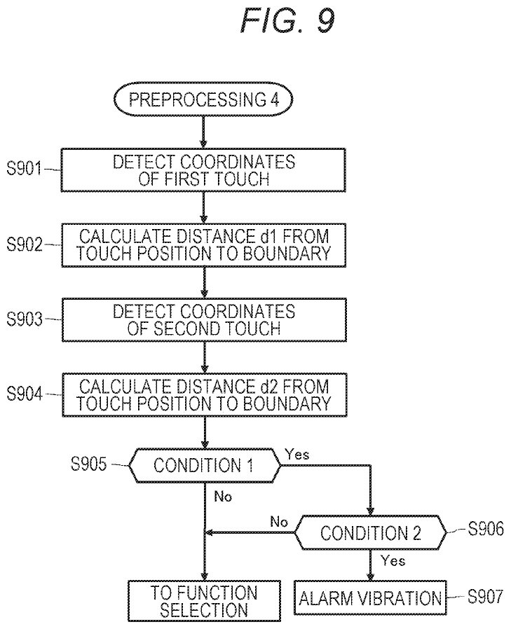

FIG. 9 shows a processing procedure of Preprocessing 4 in the form of a flowchart. Preprocessing 4 is executed under the overall control of the main control unit 204.

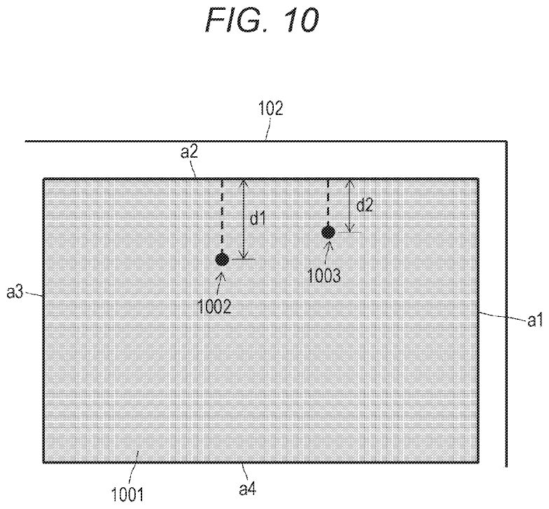

However, the processing procedure shown in FIG. 9 assumes a situation shown in FIG. 10. In FIG. 10, reference numeral 1001 is a detection region set on the touch panel 102. For the sake of convenience of description, the detection region 1001 is a quadrangle, and the four sides forming the boundary of the detection region 1001 are a1 to a4, respectively. Furthermore, reference numerals 1002 and 1003 are a position where the first touch of the fingertip is detected and a position where the second touch of the fingertip is detected in the detection region 1001, respectively. Then, the distance from the detection position 1002 to the nearest boundary a2 of the detection region 1001 is d1, and the distance from the detection position 1003 to the nearest boundary a2 of the detection region 1001 is d2.

First, the main control unit 204 detects the coordinates of the first fingertip touch position 1002 in the detection region 1001 (step S901). Then, the distance d1 from the touch position 1002 to the nearest boundary a2 of the detection region 1001 is calculated (step S902).

Next, the main control unit 204 detects the coordinates of the second fingertip touch position 1003 in the detection region 1001 (step S903). Then, the distance d2 from the touch position 1003 to the nearest boundary a2 of the detection region 1001 is calculated (step S904).

Then, the main control unit 204 checks whether Condition 1 of Preprocessing 4 is satisfied (step S905). Condition 1 includes two conditions: the current touch detection coordinates are closer to the boundary of the detection region 1001 than the previous time (that is, d1-d2>0) and the current touch detection coordinates are within the outer peripheral specified range 802. Here, when a region whose distance from the boundary of the detection region 1001 is less than D (for example, D=0.5 mm) is defined as the outer peripheral specified range, the second condition can be expressed as 0<d2<D.

In a case where Condition 1 of Preprocessing 4 is satisfied (Yes in step S905), the main control unit 204 further checks whether Condition 2 of Preprocessing 4 is satisfied (step S906). Condition 2 of Preprocessing 4 is specifically that the second touch detected in step S903 is not an erroneous contact. For example, in a case where the distance at which the touch coordinates approach the boundary of the detection region 1001 exceeds a predetermined value E (for example, E=20 mm) at a specific time Δt (for example, Δt=20 milliseconds) (that is, d1−d2>E>>0), it is determined that the touch is an unintentional erroneous contact of the user. Then, in a case where the second touch is not an erroneous contact, that is, Condition 2 of Preprocessing 4 is satisfied (Yes in step S906), the user is warned by the vibration (alarm vibration) of the vibration unit 103 (step S907), and the protrusion of the finger from the detection region 1001 is prevented.

Note that, in step S907, the main control unit 204 may issue a warning to the user by using any means other than vibration, instead of or simultaneously with the alarm vibration. For example, information display may be executed on the display screen of the display unit 101 to give a notification that the finger is about to protrude from the detection region of the touch panel 102. This information display includes display of icons and characters. The display of icons or characters is not particularly limited as long as the user is notified that the finger is about to protrude from the detection region of the touch panel, but can be various such as the display of icons or characters indicating the warning or display of highlighting the outer frame of the display unit 101. Furthermore, on the basis of the boundary of the touch detection position and the detection region, an icon imitating an arrow that gives a notification of moving away from the outside of the detection region may be displayed. Furthermore, instead of the display unit 101 on the back surface of the main body of the imaging apparatus 100, the screen of the finder 104 (in the case of an electronic finder) may be used to display information for warning the user.

On the other hand, in a case where Condition 1 of Preprocessing 4 is not satisfied (No in step S905), the processing proceeds to next function selection processing (step S306). For example, in the case of d1-d2<0 or D<d2, it can be determined that the finger is not about to move out of the detection region of the touch panel 102, and thus the notification by vibration is not given. Furthermore, in the case of d2<0, the touch coordinates detected the second time are outside the detection region, or the current touch coordinates position is outside the detection region, and it is not regarded as a normal touch operation on the touch panel 102 using the touch pad AF function or the touch AF function, and therefore the notification by vibration is not given.

Furthermore, in a case where Condition 1 of Preprocessing 4 is satisfied (Yes in step S905) but Condition 2 of Preprocessing 4 is not satisfied (No in step S906), the processing proceeds to next function selection processing (step S306). When the distance over which the touch coordinate position has moved within the specific time Δt exceeds the predetermined value E (d1-d2>E), it is possible to determine that the second touch is an erroneous contact, and therefore the notification by vibration is not given.

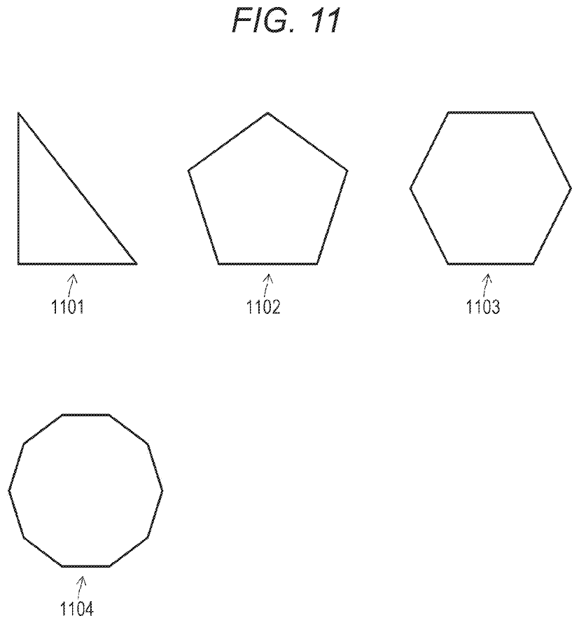

Note that FIGS. 8 and 10 draw the detection region having a quadrangle for the sake of convenience, but the shape of the detection region that can be set on the touch panel 102 is not limited to a quadrangle. For example, in FIG. 11, a detection region having a triangle shown by reference numeral 1101, a pentagon shown by reference numeral 1102, a hexagon shown by reference numeral 1103, or a decagon shown by reference numeral 1104 may be set, or a detection region having another polygonal shape, which is not shown, may be set. Of course, it is also possible to set a detection region having any shape other than a polygon.

Furthermore, the detection region on the touch panel 102 can be set at an arbitrary point of time after starting the use of the imaging apparatus 100, including the time of the initial setting of the imaging apparatus 100. For example, the user may be allowed to select a desired one from several types of detection regions prepared in advance in the imaging apparatus 100.

Alternatively, the user may freely set the detection region. For example, it is possible to adopt a method in which the user himself/herself specifies the vertices of the detection region (for example, in the case of a quadrangle, the four vertices are specified), a method in which the user himself/herself specifies the boundary of the detection region (for example, in the case of a quadrangle, the four sides are specified), or the like.

Note that no matter what detection region with any shape is used, it is desirable that the right half of the touch panel 102 be set as the detection region having a desired shape avoiding the place that the nose tip of the user tends to contact, or when the eye sensor detects the approach of an object to the finder 104, the right half of the touch panel 102 be set as the detection region having a desired shape avoiding the contact region 702 equal to or smaller than a predetermined area on the touch panel 102.

<<Function 1>>

Function 1 selectable in step S306 is a function of giving a notification of the focus by vibration. Digital cameras and the like that give a notification of being focused by making a beeping sound are well known, but in a quiet capturing environment where no sound can be produced, sound output may be turned off. Then, it may be difficult for the user to hear the focus notification sound. According to Function 1, the notification of the focus can be given to the user by vibration as an alternative means of the notification by sound. In addition, although it is possible to present that the focus is achieved by changing the color of the focus frame, the focus frame is often hidden by the finger operating the touch panel 102, and the change in the color of the focus frame can be overlooked. The vibration can notify the user of the focus regardless of the position of the fingertip.

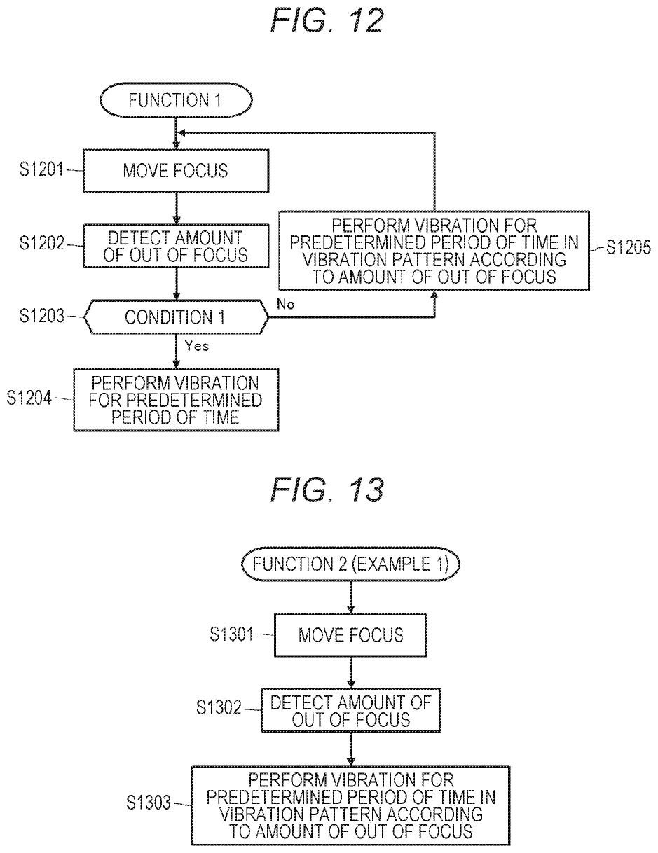

FIG. 12 shows, in the form of a flowchart, a processing procedure of Function 1 for giving a notification of the focus by vibration. The illustrated processing procedure is executed under the overall control of the main control unit 204.

For example, each time the focus frame is moved on the touch panel 102 (step S1201), the imaging unit 201 detects the amount of out of focus (step S1202).

Then, the main control unit 204 checks whether the amount of out of focus meets Condition 1 of Function 1 (step S1203). Condition 1 mentioned here is specifically that the amount of out of focus is 0, that is, the subject is in focus.

In a case where the amount of out of focus is 0 (Yes in step S1203), the main control unit 204 vibrates the vibration unit 103 for a certain period of time (step S1204), and notifies the user that the imaging unit 201 is focusing on the subject.

On the other hand, in a case where the amount of out of focus is not 0 (No in step S1203), the main control unit 204 vibrates the vibration unit 103 for a certain period of time in a vibration pattern depending on the amount of out of focus (step S1205) to notify the user of the degree of focus.

In step S1205, for example, as the focus frame touched by the user is closer to being in focus, the vibration cycle, amplitude, number of times, and time of the vibration unit 103 are changed (for example, the cycle of vibration is shortened) to notify the user of the degree of focus. In some cases, the region touched by the user with the finger may not be in focus, and the user may press the shutter without realizing it. Furthermore, the region touched by the user is hidden by the finger, and there is also a case where the user wanted to focus in a region slightly away from that region. By presenting the degree of focus by vibration, these problems can be solved.

Alternatively, in step S1205, the vibration cycle, amplitude, number of times, and time of the vibration unit 103 are changed (for example, the cycle of vibration is shortened) as the focus approaches a specific object designated by the user in advance (for example, a pupil or a face registered in advance) to notify the user of the degree of focus.

According to Function 1, a notification of the degree of focus can be given to the user in an easy-to-understand manner by the vibration pattern. Furthermore, it is difficult to know where the focus is achieved merely by touching the touch panel 102, but according to Function 1, such a problem can also be solved.

<<Function 2>>

Function 2 selectable in step S306 is a function of giving a notification of the inter-subject distance by vibration. According to Function 2, for example, when the focus frame is moved using the touch pad AF function, a notification of the distance between the subject in the focused region and the imaging apparatus 100 can be given to the user by vibration.

FIG. 13 shows, in the form of a flowchart, an example of a processing procedure of Function 2 for giving a notification of the inter-subject distance by vibration. The illustrated processing procedure is executed under the overall control of the main control unit 204.

For example, each time the focus frame is moved on the touch panel 102 (step S1301), the imaging unit 201 detects the amount of out of focus (step S1302).

Then, the main control unit 204 vibrates the vibration unit 103 for a certain period of time in a vibration pattern depending on the detected amount of out of focus (step S1303) to notify the user of the degree of focus.

In step S1303, for example, as the focus frame touched by the user is closer to being in focus, the vibration cycle, amplitude, number of times, and time of the vibration unit 103 are changed (for example, the cycle of vibration is shortened) to notify the user of the degree of focus.

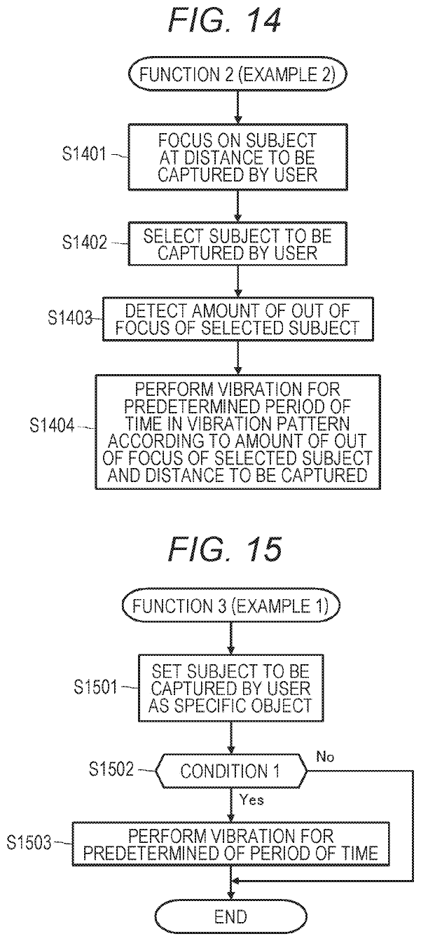

Furthermore, FIG. 14 shows, in the form of a flowchart, another example of a processing procedure of Function 2 for giving a notification of the inter-subject distance by vibration. The illustrated processing procedure is executed under the overall control of the main control unit 204.

First, the object at a distance that the user wants to capture is focused (step S1401).

Next, the user uses the touch panel 102, for example, to select a subject to be captured (step S1402).

Then, the imaging unit 201 detects the amount of out of focus of the selected subject (step S1403). The main control unit 204 vibrates the vibration unit 103 for a certain period of time in a vibration pattern depending on the amount of out of focus of the selected subject from the distance to be captured (step S1404) to notify the user of the degree of focus.

In step S1404, for example, as the focus frame touched by the user is closer to being in focus, the vibration cycle, amplitude, number of times, and time of the vibration unit 103 are changed (for example, the cycle of vibration is shortened) to notify the user of the degree of focus.

Function 2 is effective in capturing, for example, a dynamic subject such as a train.

In a case where Function 2 is implemented according to the processing procedure shown in FIG. 13, the user can grasp the situation, such as how far the dynamic subject is, which is difficult to distinguish from the screen, from the vibration pattern.

Furthermore, in a case where Function 2 is implemented according to the processing procedure shown in FIG. 14, in a case where the user wants to capture a dynamic subject at a desired capturing distance, the user can set the subject and the capturing distance as desired and know the optimum capturing timing from the vibration pattern.

<<Function 3>>

Function 3 selectable in step S306 is a function of giving a notification that the specific object has been recognized by vibration. An important subject other than the subject of interest can enter the angle of view during capturing (for example, when a rare bird is to be captured, another bird of the same type enters the angle of view). Furthermore, in some cases, a subject of interest, which does not move, is to be captured at the moment of movement. According to Function 3, a notification of such timing can be given by vibration, and the user does not miss a photo opportunity.

FIG. 15 shows, in the form of a flowchart, an example of a processing procedure of Function 3 for giving a notification of the fact that a specific object has been recognized by vibration. The illustrated processing procedure is executed under the overall control of the main control unit 204.

First, the user sets a subject to be captured as a specific object (step S1501).

There are various methods for setting a specific object. For example, it may be an object registered in advance such as a face. Furthermore, it is also possible to set an object that moves in an arbitrarily settable region in the capturing screen, an object that includes an arbitrarily settable color, or the like as the specific object. Alternatively, an arbitrarily settable region centered on the focused portion (for example, designated by the touch of the fingertip) on the touch panel 102 can be set as the specific object.

Next, the main control unit 204 checks whether Condition 1 of Function 3 is satisfied (step S1502). Condition 1 is specifically that the specific object set in step S1501 has entered the capturing screen.

Then, when the specific object enters the capturing screen (Yes in step S1502), the main control unit 204 vibrates the vibration unit 103 for a certain period of time (step S1503) to notify the user that the specific object has entered the capturing screen. By changing the vibration cycle, amplitude, number of times, and time of the vibration unit 103 (for example, shortening the vibration cycle), the user is notified that the specific object has entered the capturing screen.

For example, in a case where a subject that is expected to suddenly enter the capturing screen is to be captured, it is effective to implement Function 3 according to the processing procedure shown in FIG. 15. For example, when bird information is set in the imaging apparatus 100 in step S1501 during capturing of a wild bird, it is less likely to miss a photo opportunity when a desired wild bird flies.

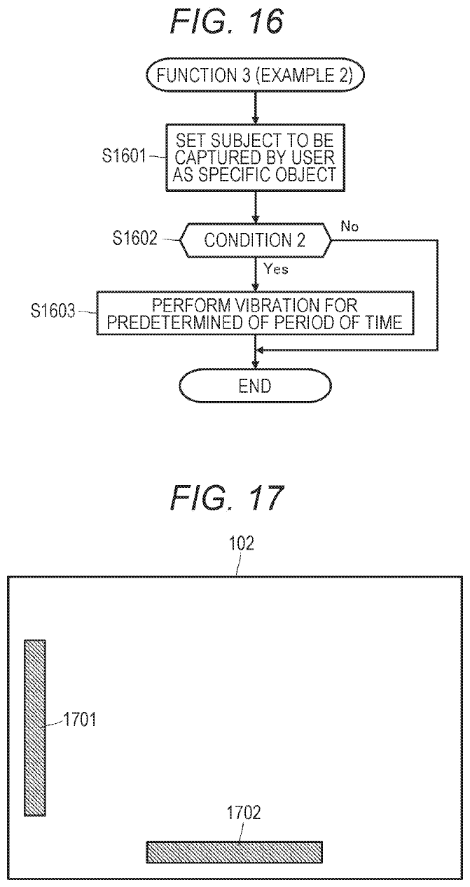

Furthermore, FIG. 16 shows, in the form of a flowchart, another example of a processing procedure of Function 3 for giving a notification of the fact that a specific object has been recognized by vibration. The illustrated processing procedure is executed under the overall control of the main control unit 204.

First, the user sets a subject to be captured as a specific object (step S1601). There are various methods for setting a specific object. Similarly to the above, it is possible to set a previously registered object such as a face, a region arbitrarily set in the capturing screen, a focused portion on the touch panel 102, or the like as the specific object.

Next, the main control unit 204 checks whether Condition 2 of Function 3 is satisfied (step S1602). Condition 2 is specifically that the specific object set in step S1601 has moved.

Then, when the specific object moves (Yes in step S1602), the main control unit 204 vibrates the vibration unit 103 for a certain period of time (step S1603) to notify the user that the specific object has moved. By changing the vibration cycle, amplitude, number of times, and time of the vibration unit 103 (for example, shortening the vibration cycle), the user is notified that the specific object has moved.

For example, in a case where a subject whose stationary state continues but is expected to suddenly move is to be captured, it is effective to implement Function 3 according to the processing procedure shown in FIG. 16. For example, when bird information is set in the imaging apparatus 100 in step S1601 during capturing of a wild bird, it is less likely to miss a photo opportunity when a wild bird floating on the water surface and standing still suddenly flaps.

<<Function 4>>

Function 4 selectable in step S306 is a function of guiding the user's finger to the subject by vibration. Function 4 can be applied, for example, in a case where the user uses the touch pad AF function while looking through the finder 104 or in a case where the user uses the touch AF function for giving an instruction on auto focus and capturing with one touch on the touch panel 102.

Function 4 is based on the premise that the vibration unit 103 is capable of presenting two-dimensional information such as directions, that is, having a function of giving a sense of direction to the fingertip of the user who operates the touch panel 102.

FIG. 17 shows a configuration example of the vibration elements of the vibration unit 103 for giving a sense of direction to the vibration to the fingertip. In the illustrated example, two vibration elements 1701 and 1702 constituting the vibration unit 103 are arranged on the back surface of the touch panel 102 so that their vibration directions are orthogonal to each other. The vibration control unit 203 controls the vibration of each of the vibration elements 1701 and 1702 on the basis of an instruction from the main control unit 204. Then, a combination of vibration patterns (vibration cycle, amplitude, number of times, time) of each of the vibration elements 1701 and 1702, that is, a sense of direction can be given to the user's fingertip operating the touch panel 102. Furthermore, by actively utilizing such a direction presenting function, the position of the user's finger operating the touch panel 102 can be guided to the focus frame position recommended by the camera system.

Note that the configuration of the vibration unit 103 shown in FIG. 17 is merely an example. Furthermore, the number of vibration elements constituting the vibration unit 103 is not limited to two, but three or more vibration elements may be arranged on the back surface of the touch panel 102.

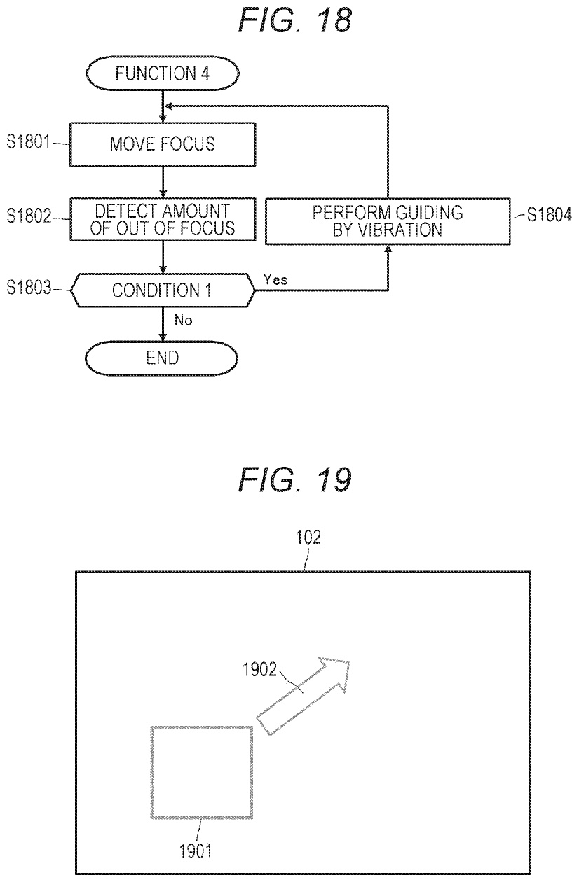

FIG. 18 shows, in the form of a flowchart, a processing procedure of Function 4 for guiding the user's finger to the subject by vibration. The illustrated processing procedure is executed under the overall control of the main control unit 204.

For example, each time the focus frame is moved on the touch panel 102 (step S1801), the imaging unit 201 detects the amount of out of focus (step S1802).

Then, the main control unit 204 checks whether the touch detection position on the touch panel 102 meets Condition 1 of Function 4 (step S1803). Condition 1 mentioned here is, specifically, that the touch detection position on the touch panel 102 does not match the focus frame position recommended by the camera system.

When the touch detection position on the touch panel 102 does not match the focus frame position recommended by the camera system (Yes in step S1803), the main control unit 204 vibrates the vibration unit 103 to guide the position of the user's finger in the direction of the focus frame position recommended by the camera system (step S1804).

Note that when vibrating the vibration unit 103 in step S1804, the vibration pattern may be changed in addition to presenting the direction. For example, as the touch detection position on the touch panel 102 becomes closer to the focus frame position recommended by the camera system, the vibration cycle, amplitude, number of times, and time of the vibration unit 103 are changed (for example, the vibration cycle is shortened). Thus, the user may be notified that the finger has approached the recommended position.

Furthermore, the method of determining the focus frame position recommended by the camera system is arbitrary. For example, a previously registered object such as a face may be recommended as the focus frame position. Alternatively, an object specified on the basis of the user's past capturing history or the like may be recommended as the focus frame position.

Furthermore, as Function 4, in addition to guiding the user's finger to the subject by vibration as described above, the user's finger may be guided to the focus frame position recommended by the camera system by video presentation.

FIG. 19 shows a configuration example of a screen for guiding to a focus frame position recommended by the camera system by video presentation. In the drawing, reference numeral 1901 denotes the focus frame position currently set by the touch of the fingertip. Furthermore, reference numeral 1902 is an arrow indicating the moving direction to the focus frame position recommended by the camera system.

For example, in a case where the user uses the touch pad AF function while looking through the finder 104, the user rarely sees the video presentation shown in FIG. 19. On the other hand, when the user uses the touch AF function while observing the display screen of the display unit 101, it is extremely effective because the direction can be presented by video together with the direction presentation by vibration. Conversely, in a case where the user uses the touch pad AF function while looking through the finder 104, the presentation by video has almost no meaning, and Function 4 for guiding the user's finger to the subject by vibration is extremely effective.

Note that the notification to the user using the screen display as shown in FIG. 19 may be performed, not on the display unit 101 on the back surface of the main body of the imaging apparatus 100 (or together with the display unit), but on the screen of the finder 104 (in the case of an electronic finder).

As described above, with the imaging apparatus 100 according to the present embodiment, it is possible to present useful information to the user by utilizing the vibration given to the touch panel 102 by the vibration unit 103. The main advantages of the imaging apparatus 100 according to the present embodiment are listed below.

(1) When the user performs capturing while looking through the finder 104 and while moving the focus frame using the touch pad AF function, the imaging apparatus 100 can notify the user by vibration before the fingertip unintentionally comes off to the outside of the detection region of the touch panel 102. Therefore, it is possible to prevent the user from missing an important photo opportunity.

(2) The detection region on the touch panel 102 can be freely set and changed by the user. For example, erroneous detection or erroneous recognition of the contact of the nose tip can be prevented by avoiding a place that the nose tip nose is likely to come into contact with when the user performs capturing while looking through the finder 104 from the detection region.

(3) In a quiet capturing environment in which the notification sound cannot be output or in a capturing environment in which the notification sound cannot be heard due to noise, the imaging apparatus 100 can give a notification of focus or the like by vibration as an alternative to the notification sound.

(4) In a case where the user uses the touch AF function while observing the display screen of the display unit 101, the focus frame is hidden by the finger and the focus state cannot be visually confirmed, but the focus state can be recognized on the basis of the notification by vibration from the imaging apparatus 100, and the position can be finely adjusted.

(5) Since the imaging apparatus 100 has a function of giving a notification of the distance from the subject by vibration, the user can determine the change in the distance from the subject by vibration even in a situation where it is difficult to determine the distance only by the capturing screen, and it is possible to capture a moving subject at an appropriate timing.

(6) The imaging apparatus 100 can designate a specific object in advance, and give a notification by vibration when the object suddenly enters the capturing screen or when the object remains stationary but suddenly starts moving. By using such a function, the user can reduce the number of times that the user misses a good photo opportunity.

(7) The imaging apparatus 100 has a function that gives a sense of direction to vibrations to the fingertips. Using this function, it is possible to achieve new capturing assistance functions such as guiding the user's fingertip to the focus frame recommended by the camera system.

Note that, as the description of the imaging apparatus 100 of the present embodiment, a series of preprocessing from Preprocessing 1 to Preprocessing 4 and the configuration of each of Function 1 to Function 4 have been described. However, the imaging apparatus 100 may have only some of Preprocessing 1 to Preprocessing 4, for example, constituting Preprocessing 4 only. Furthermore, the imaging apparatus may have only some of Function 1 to Function 4, for example, constituting Function 1 only.

### INDUSTRIAL APPLICABILITY

The technology disclosed in the present specification has been described in detail with reference to the specific embodiment. However, it is obvious that those skilled in the art can modify or substitute the embodiment without departing from the gist of the technology disclosed in the present specification.

In the present specification, the embodiment in which the technology disclosed in the present specification is applied to the imaging apparatus 100 including the finder and the touch panel as illustrated in FIG. 1 has been mainly described, but the technology disclosed in the present specification is not limited thereto. The technology disclosed in the present specification can be similarly applied to various types of information devices such as smartphones equipped with a capturing function and a touch panel.

In short, the technology disclosed in the present specification has been described by way of example, and the contents described in the present specification should not be construed limitedly. In order to determine the gist of the technology disclosed in the present specification, the claims should be considered.

Note that the technology disclosed in the present specification may have the following configurations.

(1) An imaging apparatus including:

a detection unit that detects a touch position with respect to a detection region; and

a control unit that controls a notification on the basis of a relationship between a first touch position detected by the detection unit and a second touch position detected after the first touch position.

(2) The imaging apparatus according to (1), further including

a vibration unit that gives vibration to the imaging apparatus, in which

the control unit controls a notification by the vibration.

(3) The imaging apparatus according to (1) or (2), in which

the control unit controls a notification on a screen of a display unit.

(4) The imaging apparatus according to any of (1) to (3), in which

the control unit controls the notification on the basis of a relationship between a first distance between the detection region and the first touch position and a second distance between the detection region and the second touch position.

(5) The imaging apparatus according to any of (1) to (4), in which

the control unit performs control to set a specified region at a predetermined distance from a boundary of the detection region and give a notification in a case where the second touch position is detected between the boundary of the detection region and the specified region.

(6) The imaging apparatus according to any of (1) to (5), in which

in a case where the second touch position is outside the detection region, the control unit performs control to not give a notification by the vibration.

(7) The imaging apparatus according to any of (4) to (6), in which

the control unit, in a case where time when the first touch position is detected and time when the second touch position is detected are within a predetermined time and a difference between the first distance and the second distance exceeds a predetermined value, performs control to not give the notification.

(8) The imaging apparatus according to any of (1) to (7), further including

a display unit that displays a captured image, in which

the detection region includes a region set in the display unit and includes a region for setting a focus frame of the captured image.

(9) The imaging apparatus according to (8), in which

the control unit sets the detection region specified by a user.

(10) The imaging apparatus according to (8) or (9), further including

a finder; and

an eye sensor that detects approach to the finder, in which

the control unit, when the eye sensor senses the approach and the detection unit detects a touch of a predetermined area or less, sets the detection region not including a place where the touch of the predetermined area or less is detected.

(11) The imaging apparatus according to (2), in which

the control unit controls the vibration unit so as not to generate vibration outside the detection region.

(12) The imaging apparatus according to any of (2) to (11), in which

the control unit controls the vibration unit so as not to generate vibration in a state immediately before capturing by the imaging apparatus.

(13) The imaging apparatus according to any of (2) to (12), in which

the control unit controls the vibration unit so as not to generate vibration when the detection unit detects a touch of a predetermined area or more.

(13-1) The imaging apparatus according to (13), in which

the control unit controls the vibration unit so as not to generate vibration when the detection unit detects contact of a second predetermined area or more.

(13-2) The imaging apparatus according to (13), in which

the control unit controls the vibration unit so as not to generate vibration when the detection unit detects a touch of a specific number of fingers or more.

(14) The imaging apparatus according to any of (2) to (13), in which

the control unit controls a condition of vibration generated in the vibration unit according to a focus state of the imaging apparatus.

(14-1) The imaging apparatus according to (14), in which

the control unit controls a vibration pattern generated in the vibration unit according to a focus state of the imaging apparatus.

(15) The imaging apparatus according to any of (2) to (14), in which

the control unit controls a condition of vibration generated in the vibration unit according to a distance between the imaging apparatus and a subject.

(15-1) The imaging apparatus according to (15), in which

the control unit controls a vibration pattern generated in the vibration unit according to the distance.

(16) The imaging apparatus according to any of (2) to (15), in which

the control unit controls a condition of vibration generated in the vibration unit according to a distance between the position to be focused and a subject.

(16-1) The imaging apparatus according to (16), in which

the control unit controls a vibration pattern generated in the vibration unit according to the distance.

(17) The imaging apparatus according to any of (2) to (16), in which

the control unit controls a condition of vibration generated in the vibration unit according to a recognition result of a specific object.

(17-1) The imaging apparatus according to (17), in which

the control unit controls a vibration pattern generated in the vibration unit according to the recognition result.

(18) The imaging apparatus according to any of (2) to (17), in which

the control unit presents a direction to a position of a specific focus frame by vibration of the vibration unit.

(19) The imaging apparatus according to (18), in which

the vibration unit includes a plurality of vibration elements including two vibration elements arranged so that vibration directions are orthogonal to each other.

(20) A notification control method in an imaging apparatus including a display unit and a touch panel superimposed on a screen of the display unit, the notification control method including:

a detection step of detecting a touch position with respect to a detection region set on the display unit; and

a control step of controlling a notification on the basis of a change in the touch position detected in the detection step.

(21) An information processing apparatus including:

a detection unit that detects a touch position with respect to a detection region; and

a control unit that controls a notification on the basis of a relationship between a first touch position detected by the detection unit and a second touch position detected after the first touch position.

### REFERENCE SIGNS LIST

100 Imaging apparatus
101 Display unit
102 Touch panel
103 Vibration unit
104 Finder
201 Imaging unit
202 Panel control unit
203 Vibration control unit
204 Main control unit

1. An imaging apparatus comprising:
a detection unit that detects a touch position with respect to a detection region; and
a control unit that controls a notification on a basis of a relationship between a first touch position detected by the detection unit and a second touch position detected after the first touch position.

2. The imaging apparatus according to claim 1, further comprising
a vibration unit that gives vibration to the imaging apparatus, wherein
the control unit controls a notification by the vibration.

3. The imaging apparatus according to claim 1, wherein
the control unit controls a notification on a screen of a display unit.

4. The imaging apparatus according to claim 1, wherein
the control unit controls the notification on a basis of a relationship between a first distance between the detection region and the first touch position and a second distance between the detection region and the second touch position.

5. The imaging apparatus according to claim 1, wherein
the control unit performs control to set a specified region at a predetermined distance from a boundary of the detection region and give a notification in a case where the second touch position is detected between the boundary of the detection region and the specified region.

6. The imaging apparatus according to claim 1, wherein
in a case where the second touch position is outside the detection region, the control unit performs control to not give a notification by the vibration.

7. The imaging apparatus according to claim 4, wherein
the control unit, in a case where time when the first touch position is detected and time when the second touch position is detected are within a predetermined time and a difference between the first distance and the second distance exceeds a predetermined value, performs control to not give the notification.

8. The imaging apparatus according to claim 1, further comprising
a display unit that displays a captured image, wherein
the detection region includes a region set in the display unit and includes a region for setting a focus frame of the captured image.

9. The imaging apparatus according to claim 8, wherein
the control unit sets the detection region specified by a user.

10. The imaging apparatus according to claim 8, further comprising
a finder; and
an eye sensor that detects approach to the finder, wherein
the control unit, when the eye sensor senses the approach and the detection unit detects a touch of a predetermined area or less, sets the detection region not including a place where the touch of the predetermined area or less is detected.

11. The imaging apparatus according to claim 2, wherein
the control unit controls the vibration unit so as not to generate vibration outside the detection region.

12. The imaging apparatus according to claim 2, wherein
the control unit controls the vibration unit so as not to generate vibration in a state immediately before capturing by the imaging apparatus.

13. The imaging apparatus according to claim 2, wherein
the control unit controls the vibration unit so as not to generate vibration when the detection unit detects a touch of a predetermined area or more.

14. The imaging apparatus according to claim 2, wherein
the control unit controls a condition of vibration generated in the vibration unit according to a focus state of the imaging apparatus.

15. The imaging apparatus according to claim 2, wherein
the control unit controls a condition of vibration generated in the vibration unit according to a distance between the imaging apparatus and a subject.

16. The imaging apparatus according to claim 2, wherein
the control unit controls a condition of vibration generated in the vibration unit according to a distance between the position to be focused and a subject.

17. The imaging apparatus according to claim 2, wherein
the control unit controls a condition of vibration generated in the vibration unit according to a recognition result of a specific object.

18. The imaging apparatus according to claim 2, wherein
the control unit presents a direction to a position of a specific focus frame by vibration of the vibration unit.

19. A notification control method in an imaging apparatus including a display unit and a touch panel superimposed on a screen of the display unit, the notification control method comprising:
a detection step of detecting a touch position with respect to a detection region set on the display unit; and
a control step of controlling a notification on a basis of a change in the touch position detected in the detection step.

20. An information processing apparatus comprising:
a detection unit that detects a touch position with respect to a detection region; and
a control unit that controls a notification on a basis of a relationship between a first touch position detected by the detection unit and a second touch position detected after the first touch position.
